(19) United States
(12) Patent Application Publication
(10) Pub. No.: US 2026/0296593 A1
(43) Pub. Date: Oct. 1, 2026

(54) FLEXIBLE TRANSMISSION STRUCTURE OF BICYCLE

(71) Applicant: Junjie FU, Dongguan (CN)

(72) Inventor: Junjie FU, Dongguan (CN)

(21) Appl. No.: 19/683,522

(22) Filed: May 20, 2026

Related U.S. Application Data
(63) Continuation-in-part of application No. PCT/CN2024/109369, filed on Aug. 2, 2024.

(30) Foreign Application Priority Data
Jan. 30, 2024 (CN) 202410127568.3

(51) Int. Cl. B62M 3/08; B62M 3/00

(52) U.S. Cl. CPC B62M 3/08; B62M 2003/006

(57) ABSTRACT

A flexible transmission structure of a bicycle includes a stop block, a right crank, a compression spring, a load-bearing rod, a chainring and a bottom bracket. The chainring is sleeved on the bottom bracket and is rotatable thereon. The load-bearing rod and the stop block are fixed on the chainring. The load-bearing rod is arranged on a front side of the right crank. The stop block is arranged on a rear side of the right crank. A load block is fixed on the load-bearing rod. Two ends of the compression spring are sleeved on spring seats on respective upper portions of the load-bearing rod and the right crank. The stop block is configured to abut against the right crank to preload the spring. When a pedal rotates to near the top dead center, the pedal is depressed to compress the spring, thereby alleviating leg fatigue during bicycle riding.

### CROSS-REFERENCE TO RELATED APPLICATIONS

This application is a continuation of PCT/CN2024/109369, filed on Aug. 2, 2024, and claims priority of Chinese Patent Application No. 202410127568.3, filed on Jan. 30, 2024, the entire contents of which are incorporated herein by reference.

### TECHNICAL FIELD

The present disclosure relates to the field of pedal-driven vehicles represented by bicycles, more particularly to a flexible transmission structure of a bicycle, wherein rigid connections between transmission components, specifically between a right crank and a chainring, or between a chain and a frame or between a freewheel and a rear wheel, are changed into movable connections or rotatable connections. A spring and a connection auxiliary component are arranged between the transmission components that have changed the connection method in this way, allowing an elastic connection between the transmission components and enabling a flexible transmission system, wherein during uphill riding or acceleration, when a pedal is depressed to pass the region near the top dead center, the spring arranged in the transmission system operates under stress, enabling the pedal to pass the region near the top dead center with reduced pedaling effort, thereby making riding easier.

### BACKGROUND

At present, in the field of pedal-driven vehicles such as bicycles, most are driven by rotary pedaling. When a pedal rotates to near the top dead center, forward pedaling becomes inefficient due to low driving torque. Additionally, the high degree of knee joint flexion at this position leads to leg fatigue during uphill riding. Existing transmission structures of the pedal-driven vehicles such as bicycles exhibit poor kinematic compatibility with human pedaling dynamics near the top dead center.

Existing geared bicycles utilize derailleurs to change gear ratios. However, the fundamental transmission structures remain unchanged, still the same as those in single-speed bicycles. Consequently, the transmission structures of the geared bicycles also demonstrate poor kinematic compatibility with human pedaling dynamics near the top dead center.

### SUMMARY

The present disclosure aims to provide a flexible transmission structure of a bicycle, wherein rigid connections between transmission components, specifically between a right crank and a chainring, or between a chain and a frame or between a freewheel and a rear wheel, are changed into movable connections or rotatable connections. A spring and a connection auxiliary component are arranged between the transmission components that have changed the connection method in this way, allowing an elastic connection between the transmission components and enabling a flexible transmission system. During uphill riding or acceleration, when a pedal is depressed to pass the region near the top dead center, the spring arranged in the transmission system deforms elastically under stress. The resistance encountered when depressing the pedal is an elastic force, enabling the pedal to pass the region near the top dead center with reduced pedaling effort, thereby making riding easier. Thus, the shortcomings of existing technologies can be addressed.

To achieve the above aim, the present disclosure employs the following technical solution.

A flexible transmission structure of a bicycle includes a spring, a connection auxiliary component and transmission components, wherein the spring and the connection auxiliary component are arranged between the transmission components of the bicycle, allowing an elastic connection between the transmission components and enabling a flexible transmission system for the bicycle.

The spring is a compression spring. The connection auxiliary component includes a load-bearing rod and a stop block. The transmission component includes a right crank and a chainring. A left crank and the right crank are fixedly connected to left and right ends of a bottom bracket. The chainring is sleeved on the bottom bracket or sleeved on the cylindrical portion of the right crank, and is configured to be rotatable on the bottom bracket or rotatable on the cylindrical portion of the right crank. The load-bearing rod and the stop block are fixed on the chainring, and the load-bearing rod is arranged on a front side of the right crank (where, when the right crank is driven to rotate on the bicycle, one side in front of the right crank is referred to as the front side and one side behind it as a rear side). The stop block is arranged on the rear side of the right crank. A load block is fixed on the load-bearing rod. Spring seats are fixed on upper portions of the load-bearing rod and the right crank respectively, and two ends of the compression spring are sleeved on the two spring seats. The stop block is configured to abut against the right crank to preload the spring.

The spring is a tension spring. The connection auxiliary component includes: a tension rod, a load block and a stop block. The transmission component includes a right crank and a chainring. The chainring is sleeved on the bottom bracket or sleeved on the cylindrical portion of the right crank, and is configured to be rotatable on the bottom bracket or rotatable on the cylindrical portion of the right crank. The tension rod and the load block are fixed on the chainring. The tension rod is arranged on a rear side of the right crank, and the load block is arranged on a front side of the right crank. Two ends of the tension spring are connected to upper portions of the right crank and the tension rod. The stop block fixed on the right crank is configured to abut against the tension rod to preload the tension spring.

The spring is a tension spring. The connection auxiliary component includes: an upper swing rod, a tension pulley, a limit rod, a tension wheel, a lower swing rod and a torsion spring. The transmission component includes: a sprocket, a frame, a freewheel and a chain. The length of the chain is configured to be increased (that is, the chain is configured to be longer) to allow slack in its free state. One end of the upper swing rod is hinged to the frame while the other end thereof is connected to the tension pulley. The tension spring is arranged below the upper swing rod. One end of the tension spring is connected to the upper swing rod while the other end thereof is connected to the frame. The tension pulley is configured to press downward against the upper section of the chain configured to transmit power between the sprocket and the freewheel. A lower end of the limit rod is fixed on the frame while an upper end thereof abuts against a lower side of the upper swing rod. One end of the lower swing rod is hinged to the frame while the other end thereof is connected to the tension wheel. Two arms of the torsion spring are configured to abut against the frame and the lower swing rod respectively. The tension wheel is configured to press downward against a lower section of the chain. The elasticity of the torsion spring can maintain the lower section of the chain under certain tension to prevent the chain slack or derailment.

The spring is a tension spring. The connection auxiliary component includes: an upper swing rod, a tension pulley, a limit rod, a tension wheel, a lower swing rod and a torsion spring. The transmission component includes: a sprocket, a frame, a freewheel and a chain. The chain is configured to be longer to allow slack in its free state. One end of the upper swing rod is hinged to the frame while the other end thereof is connected to the tension pulley. The tension spring is arranged above the upper swing rod. One end of the tension spring is connected to the upper swing rod while the other end thereof is connected to the frame. The tension pulley is configured to push upward against the upper section of the chain configured to transmit power between the sprocket and the freewheel. A lower end of the limit rod is fixed on the frame while an upper end thereof hooks onto the upper swing rod. Two arms of the torsion spring are configured to abut against the frame and the lower swing rod respectively, enabling the tension wheel to push upward against a lower section of the chain, thereby maintaining the lower section of the chain under tension to prevent the chain slack or derailment.

The spring is a tension spring. The connection auxiliary component includes: a support sleeve, a retaining ring, a connecting sleeve, a load block, a driven rod and a tension rod. The transmission component includes a freewheel and a rear wheel or a rear wheel hub. The support sleeve is fixed to a right side of the rear wheel hub of the bicycle. The connecting sleeve is sleeved on the support sleeve and is configured to be rotatable on the support sleeve. The retaining ring is configured to prevent the connecting sleeve from disengaging from the support sleeve, and the freewheel is fixedly connected to the connecting sleeve. The load block and the tension rod are fixed on the connecting sleeve. The driven rod is fixed on the support sleeve, and the driven rod is arranged on a rear side of the tension rod (where, when the freewheel and the tension rod are driven to rotate on the bicycle, one side in front of the tension rod is referred to as a front side and one side behind it as the rear side). Two ends of the tension spring are connected to respective upper portions of the tension rod and the driven rod, and a stop block fixed on the tension rod is configured to abut against the driven rod to preload the tension spring. The load block is arranged on the rear side of the driven rod.

The spring is a compression spring. The connection auxiliary component includes: a support sleeve, a retaining ring, a connecting sleeve, a driving rod, a driven rod and a stop block. The transmission component includes a freewheel and a rear wheel or a rear wheel hub. The support sleeve is fixed to a right side of the rear wheel hub of the bicycle. The connecting sleeve is sleeved on the support sleeve and is configured to be rotatable on the support sleeve. The retaining ring is configured to prevent the connecting sleeve from disengaging from the support sleeve. The driving rod is fixed on the connecting sleeve. The driven rod and the stop block are fixed on the support sleeve, and the driven rod is arranged on a front side of the driving rod. Two ends of the compression spring are sleeved on spring seats on respective upper portions of the driving rod and the driven rod. The stop block is arranged on a rear side of the driving rod and is configured to abut against the driving rod to preload the compression spring. A load block is fixed on the driven rod.

The spring is a tension spring. The connection auxiliary component includes: a tension rod, a connecting block and a stop block. The transmission component includes a right crank and a chainring. A left crank and the right crank are fixedly connected to left and right ends of the bottom bracket. The chainring is sleeved on the bottom bracket or sleeved on cylindrical portion of the right crank, and is configured to be rotatable on the bottom bracket or rotatable on the cylindrical portion of the right crank. A lower end of the tension rod is fixed on the chainring. The connecting block is fixed on a front side of the tension rod, and the connecting block is formed with a slot. The stop block fixed on the right crank is inserted into the slot of the connecting block. Two ends of the tension spring are connected to upper portions of the right crank and the tension rod.

According to the flexible transmission structure of the bicycle, a spring and a connection auxiliary component are arranged between the right crank and the chainring, or between the chain and the frame, or between the freewheel and the rear wheel, allowing an elastic connection between the transmission components and enabling a flexible transmission system between the pedals and the rear wheel. During uphill riding or acceleration, when the pedal is depressed to pass the region near the top dead center, the spring arranged in the transmission system deforms elastically under stress, and the resistance encountered when depressing the pedal is an elastic force. This enables the pedal to pass the region near the top dead center with reduced pedaling effort, thereby alleviating leg fatigue caused by pedaling in this region, enabling the pedal to quickly pass the top dead center to enter a region of higher driving torque, and making uphill and accelerated riding easier. This type of flexible transmission structure can address the shortcomings of existing technologies.

### BRIEF DESCRIPTION OF THE DRAWINGS

FIG. 1 is a structural diagram of an Embodiment 1 of the present disclosure.

FIG. 2 is a structural diagram of an Embodiment 2 of the present disclosure.

FIG. 3 is a structural diagram of an Embodiment 3 of the present disclosure.

FIG. 4 is a structural diagram of an Embodiment 4 of the present disclosure.

FIG. 5 is a structural diagram of an Embodiment 5 of the present disclosure.

FIG. 6 is a structural diagram of an Embodiment 6 of the present disclosure.

FIG. 7 is a structural diagram of an Embodiment 7 of the present disclosure.

Reference numbers in the drawings as illustrated as below:
1, chain; 2, stop block; 3, right crank; 4, right pedal; 5, compression spring; 6, load-bearing rod; 7, chainring; 71, sprocket; 72, bushing; 8, bottom bracket; 9, left crank; 10, left pedal; 13, tension rod; 14, tension spring; 16, load block; 17, connecting block; 171, first inner wall surface; 172, second inner wall surface; 20, freewheel; 21, frame; 22, upper swing rod; 24, limit rod; 25, tension pulley; 28, tension wheel; 29, lower swing rod; 30, torsion spring; 42, support sleeve; 43, retaining ring; 44, connecting sleeve; 48, driven rod; 58, driving rod.

### DESCRIPTION OF EMBODIMENTS

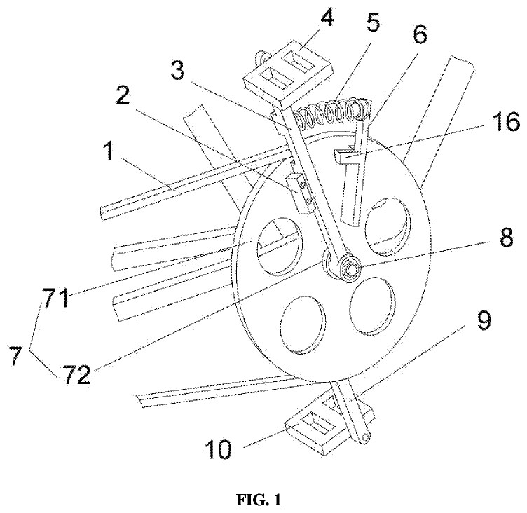

Referring to FIG. 1, an Embodiment 1 of the present disclosure includes: a stop block 2, a right crank 3, a compression spring 5, a load-bearing rod 6, a chainring 7, a bottom bracket 8. A left crank 9 and the right crank 3 are fixedly connected to left and right ends of the bottom bracket 8. The chainring 7 in the present embodiment is composed of a sprocket 71 and a bushing 72 fixed together.

The chainring 7 is sleeved on the bottom bracket 8 or sleeved on the cylindrical portion of the right crank 3, and is configured to be rotatable on the bottom bracket 8 or rotatable on the cylindrical portion of the right crank 3. That is, the chainring 7 is rotatably connected to the bottom bracket 8 or rotatably connected to the cylindrical portion of the right crank 3 (in contrast to existing bicycles where the chainring and the right crank are rigidly fixed to the bottom bracket). The load-bearing rod 6 and the stop block 2 are fixed on the chainring 7, and the load-bearing rod 6 is arranged on a front side of the right crank 3 (where, when the right crank is driven to rotate on the bicycle, one side in front of the right crank is referred to as the front side and one side behind it as a rear side). The stop block 2 is arranged on the rear side of the right crank 3. A load block 16 is fixed on the load-bearing rod 6. Spring seats are fixed on upper portions of the load-bearing rod 6 and the right crank 3 respectively, and two ends of the compression spring 5 are sleeved on the two spring seats. The stop block 2 is configured to abut against the right crank 3 to preload the spring 5.

During uphill riding or acceleration, when a right pedal 4 rotates to near the top dead center, the right pedal 4 is depressed clockwise, the compression spring 5 is compressed, and the right pedal 4 can pass the top dead center with reduced pedaling effort. Then, the right pedal 4 can quickly enter a region of higher driving torque, where the compression spring 5 is further compressed. When the right crank 3 comes into contact with the load block 16, any further increase in the depressing force on the right pedal 4 is directly and rigidly transmitted to the chainring 7. The load block 16 is configured to block the right crank 3 to prevent the compression spring 5 being damaged. When the right pedal 4 rotates to near the bottom dead center, the driving torque decreases and the pressure on the compression spring 5 is reduced. At this time, the bicycle coasts and the compression spring 5 extends (with the right crank 3 coming into contact with the stop block 2), pushing the chainring 7 to rotate a further angle clockwise, preparing for a left pedal 10 to easily pass the top dead center. At the same time, the left pedal 10 rotates to near the top dead center, where the left pedal 10 is depressed and the compression spring 5 is compressed. The left pedal 10 can pass the top dead center with reduced pedaling effort and quickly enter a region of higher driving torque. The compression spring 5 is further compressed. When the right crank 3 comes into contact with the load block 16, any further increase in the depressing force on the left pedal 10 is directly and rigidly transmitted to the chainring 7. When the left pedal 10 rotates to near the bottom dead center, the driving torque decreases, and the pressure on the compression spring 5 is reduced, then the compression spring 5 extends (with the right crank 3 coming into contact with the stop block 2), preparing for the right pedal 4 to easily pass the top dead center. At this time, the right pedal 4 rotates to near the top dead center. By alternately depressing the left and right pedals, each through a half-rotation around the bottom bracket 8, the chainring 7 is driven to rotate, pulling the upper section of the chain 1 to drive the bicycle forward. During one pedal revolution, the compression spring 5 undergoes compression and extension twice.

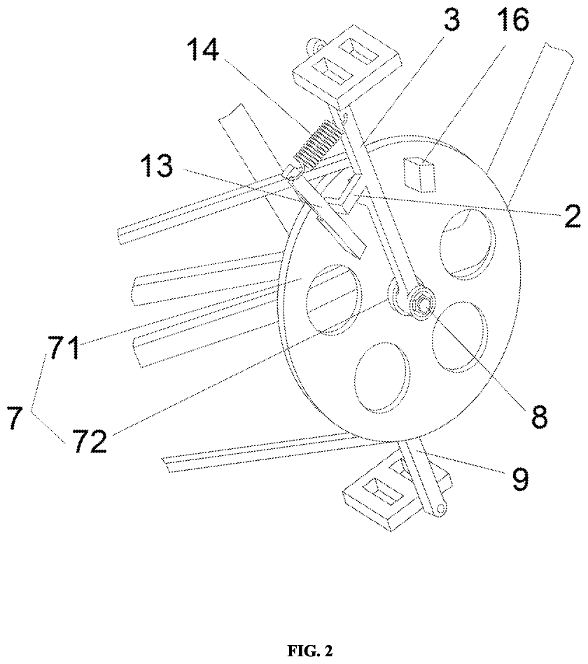

Referring to FIG. 2, an Embodiment 2 of the present disclosure includes: a tension rod 13, a tension spring 14, a right crank 3, a load block 16, a chainring 7 and a bottom bracket 8. A left crank 9 and the right crank 3 are fixedly connected to left and right ends of the bottom bracket 8. The chainring 7 is sleeved on the bottom bracket 8 or sleeved on the cylindrical portion of the right crank 3, and is configured to be rotatable on the bottom bracket 8 or rotatable on the cylindrical portion of the right crank 3. That is, the chainring 7 is rotatably connected to the bottom bracket 8 or rotatably connected to the cylindrical portion of the right crank 3. The tension rod 13 and the load block 16 are fixed on the chainring 7. The tension rod 13 is arranged on a rear side of the right crank 3, and the load block 16 is arranged on a front side of the right crank 3. Two ends of the tension spring 14 are connected to upper portions of the right crank 3 and the tension rod 13, and the stop block 2 fixed on the right crank 3 is configured to abut against the tension rod 13 (the stop block 2 can also be fixed on the tension rod 13 to abut against the right crank 3) to preload the tension spring 14. Specifically, when pedaling increases the tension in the tension spring 14 and extends it to a certain extent, the right crank 3 comes into contact with the load block 16, after which any further increase in the driving force is then directly transmitted to the chainring 7. In the present embodiment, the principle and process to enable the pedal to easily pass the top dead center are substantially the same as those in Embodiment 1.

It is to be noted that in Embodiment 1 and Embodiment 2, the chainring 7 is composed of a sprocket 71 and a bushing 72 fixed together.

The spring in Embodiment 1 and Embodiment 2 can also adopt a leaf spring and the like.

In Embodiment 1 and Embodiment 2, a self-lubricating bearing or a needle bearing and the like can be arranged between the bottom bracket 8 or the cylindrical portion of the right crank 3 and a hole of the chainring 7 to reduce friction.

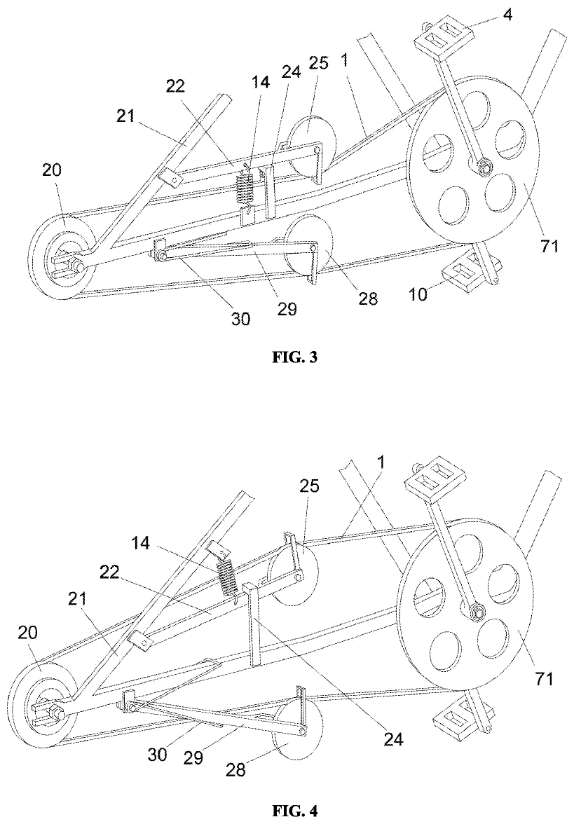

Referring to FIG. 3, an Embodiment 3 of the present disclosure includes: a freewheel 20, a frame 21, an upper swing rod 22, a tension spring 14, a limit rod 24, a tension pulley 25, a chain 1, a sprocket 71, a tension wheel 28, a lower swing rod 29 and a torsion spring 30. The chain 1 is configured to be longer to allow slack in its free state. One end of the upper swing rod 22 is hinged to the frame 21 while the other end thereof is connected to the tension pulley 25. The tension pulley 25 is a small sprocket or pulley. The tension spring 14 is arranged below the upper swing rod 22. One end of the tension spring 14 is connected to the upper swing rod 22 while the other end thereof is connected to the frame 21. The tension pulley 25 is configured to press downward against the upper section of the chain 1 configured to transmit power between the sprocket 71 and the freewheel 20. A lower end of the limit rod 24 is fixed on the frame 21 while an upper end thereof abuts against a lower side of the upper swing rod 22. One end of the lower swing rod 29 is hinged to the frame 21 while the other end thereof is connected to the tension wheel 28. The tension wheel 28 is a small sprocket or pulley too. Two arms of the torsion spring 30 are configured to abut against the frame 21 and the lower swing rod 29 respectively. The tension wheel 28 is configured to press downward against a lower section of the chain 1. The elasticity of the torsion spring 30 can maintain the lower section of the chain 1 under certain tension to prevent the chain 1 slack or derailment.

It is to be noted that the sprocket 71 of the present embodiment is fixedly connected to the right crank 3 directly, similar to a conventional bicycle.

During uphill riding or acceleration, when the left pedal 10 rotates to near the bottom dead center, the driving torque decreases, and the tension in the upper section of the chain 1 configured to transmit driving force is reduced. The tension spring 14 pulls the upper swing rod 22 to swing downward, and the tension pulley 25 presses downward against the upper section of the chain 1. At this time, the bicycle coasts; and the upper section of the chain 1 pulls the freewheel 20 to rotate a further angle clockwise, thereby forming the upper section of the chain 1 into a curve to increase its length. At the same time, the right pedal 4 rotates to near the top dead center, and depress the right pedal 4 clockwise to pull the upper section of the chain 1. The tension in the upper section of the chain 1 causes extension of the tension spring 14 and shortening of the upper section of the chain 1. At this time, the upper section of the chain 1 exhibits elasticity or flexibility, functioning similarly to a tension spring. The resistance encountered when pushing the right pedal 4 comes from the elastic or flexible resistance of the upper section of the chain 1. As a result, the right pedal 4 can pass the top dead center with reduced pedaling effort and quickly enter a region of higher driving torque. When the right pedal 4 rotates to near the bottom dead center, the tension in the upper section of the chain 1 decreases; and the tension spring 14 pulls the tension pulley 25 to move downward to elongate the upper section of the chain 1, preparing for the left pedal 10 to easily pass the top dead center. At the same time, the left pedal 10 rotates to near the top dead center. Depress the left pedal 10 clockwise, then the upper section of the chain 1 is pulled, and the tension in the upper section of the chain 1 causes extension of the tension spring 14 and shortening of the upper section of the chain 1. At this time, the upper section of the chain 1 exhibits elasticity or flexibility, functioning similarly to a tension spring. As a result, the left pedal 10 can pass the top dead center with reduced pedaling effort and quickly enter a region of higher driving torque. By alternately depressing the left and right pedals, each through a half-rotation, the bicycle is driven forward. During one pedal revolution, the upper section of the chain 1 undergoes two cycles of elongation and shortening, while the tension pulley 25 and the tension wheel 28 swing up and down twice.

An upper end of the limit rod 24 abuts against a lower side of the upper swing rod 22, thereby being able to control the amount of increase in the length of the upper section of the chain 1. Alternatively, a bolt can be arranged on the upper end of the limit rod 24 to adjust the amount of increase in the length of the upper section of the chain 1, thereby controlling and adjusting an angle range over which the pedal can be easily driven past the top dead center.

Referring to FIG. 4, an Embodiment 4 of the present disclosure includes: a freewheel 20, a frame 21, an upper swing rod 22, a tension spring 14, a tension pulley 25, a chain 1, a sprocket 71, a limit rod 24, a tension wheel 28, a lower swing rod 29 and a torsion spring 30. The chain 1 is configured to be longer to allow slack in its free state. One end of the upper swing rod 22 is hinged to the frame 21 while the other end thereof is connected to the tension pulley 25. The tension spring 14 is arranged above the upper swing rod 22. The tension pulley 25 is configured to push upward against the upper section of the chain 1, thereby pulling upward the upper section of the chain 1 configured to transmit power between the sprocket 71 and the freewheel 20 and increasing the length of the upper section. A lower end of the limit rod 24 is fixed on the frame 21 while an upper end thereof hooks onto the upper swing rod 22 to control the amount of increase in the length of the upper section of the chain. One end of the lower swing rod 29 is hinged to the frame 21 while the other end thereof is connected to the tension wheel 28. Two arms of the torsion spring 30 are configured to abut against the frame 21 and the lower swing rod 29, whereby the tension wheel 28 can push upward against a lower section of the chain 1, thereby maintaining the lower section of the chain 1 under tension. In the present embodiment, the principle and process to enable the pedal to easily pass the top dead center are substantially the same as those in Embodiment 3.

The sprocket 71 of the present embodiment is fixedly connected to the right crank 3 directly, similar to a conventional bicycle.

The spring in Embodiment 3 and Embodiment 4 can also adopt a compression spring, an elastic cord or a rubber spring such as an elastic band. The connection auxiliary component can change accordingly.

For bicycles equipped with a derailleur, since the derailleur applies an elastic force to the lower section of the chain 1 via a guide pulley and a tension is provided to the lower section, the part that provides tension to the lower section of the chain 1 can be omitted in Embodiment 3 and Embodiment 4.

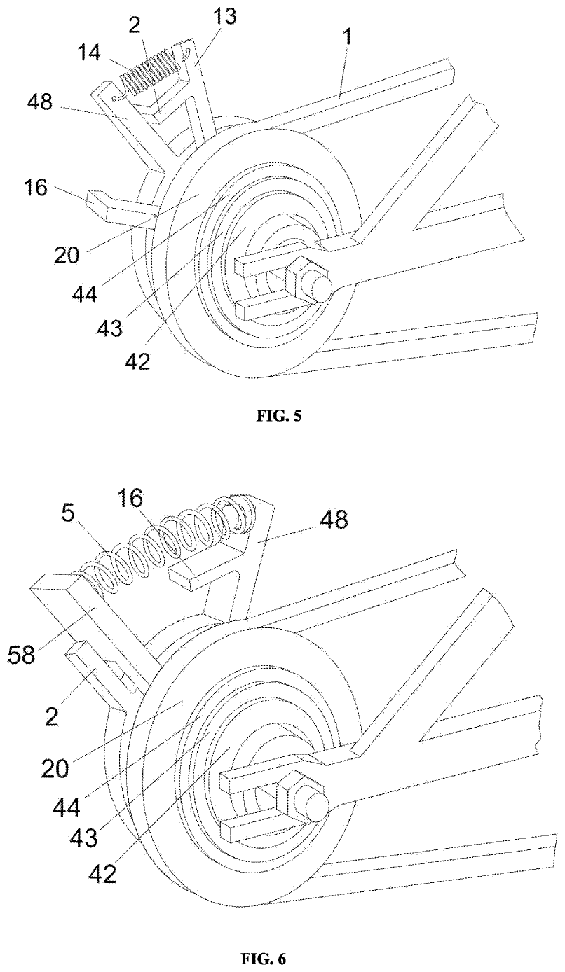

Referring to FIG. 5, an Embodiment 5 of the present disclosure includes: a support sleeve 42, a retaining ring 43, a connecting sleeve 44, a freewheel 20, a load block 16, a driven rod 48, a tension spring 14, a tension rod 13 and a chain 1. The support sleeve 42 is fixed to a right side of a rear wheel hub of the bicycle. The connecting sleeve 44 is sleeved on the support sleeve 42 and is configured to be rotatable on the support sleeve 42. The retaining ring 43 is configured to prevent the connecting sleeve 44 from disengaging from the support sleeve 42, and the freewheel 20 is fixedly connected to the connecting sleeve 44. The load block 16 and the tension rod 13 are fixed on (the flange of) the connecting sleeve 44. The driven rod 48 is fixed on (the flange of) the support sleeve 42 and is arranged on a rear side of the tension rod 13 (where, when the freewheel 20 and the tension rod 13 are driven to rotate on the bicycle, one side in front of the tension rod 13 is referred to as a front side and one side behind it as the rear side). Two ends of the tension spring 14 are connected to respective upper portions of the tension rod 13 and the driven rod 48, and a stop block 2 fixed on the tension rod 13 is configured to abut against the driven rod 48 to preload the tension spring 14. The load block 16 is arranged on the rear side of the driven rod 48.

When one of the pedals rotates to near the bottom dead center, the driving torque decreases and the driving tension in the upper section of the chain 1 decreases, and the other pedal rotates to near the top dead center. Depress clockwise the pedal near the top dead center, then the chain 1 drives the freewheel 20 to rotate clockwise and the tension rod 13 pulls the tension spring 14 to extend. Since the resistance encountered by the pedal when passing the top dead center is an elastic force, the pedal can easily pass the top dead center and quickly enter a region of higher driving torque. As the driving torque increases and the tension spring 14 extends to a certain extent, the driven rod 48 comes into contact with the load block 16, after which any further increase in the driving force is directly transmitted to the rear wheel or the rear wheel hub, thereby protecting the tension spring 14 against damage. In this way, the two pedals can easily pass the top dead center alternately, thereby driving the bicycle forward. During one pedal revolution, the tension spring 14 undergoes compression and extension twice.

Referring to FIG. 6, an Embodiment 6 of the present disclosure includes: a support sleeve 42, a retaining ring 43, a connecting sleeve 44, a freewheel 20, a stop block 2, a driving rod 58, a compression spring 5 and a driven rod 48. The support sleeve 42 is fixed to a right side of a rear wheel hub of the bicycle. The connecting sleeve 44 is sleeved on the support sleeve 42 and is configured to be rotatable on the support sleeve 42. The retaining ring 43 is configured to prevent the connecting sleeve 44 from disengaging from the support sleeve 42, and the freewheel 20 is fixedly connected to the connecting sleeve 44. The driving rod 58 is fixed on (the flange of) the connecting sleeve 44. The driven rod 48 and the stop block 2 are fixed on (the flange of) the support sleeve 42. The driven rod 48 is arranged on a front side of the driving rod 58, and two ends of the compression spring 5 are sleeved on spring seats on respective upper portions of the driving rod 58 and the driven rod 48. The stop block 2 is arranged on a rear side of the driving rod 58 and is configured to abut against the driving rod 58 to preload the compression spring 5. When the driving torque increases, the compression spring 5 is compressed. When the driving rod 58 comes into contact with a load block 16 fixed on the driven rod 48, any further increase in the driving force is directly transmitted to the rear wheel or the rear wheel hub, thereby protecting the compression spring 5 against damage. The principle and process to enable the pedal to easily pass the top dead center are substantially the same as those in Embodiment 5.

In Embodiment 5 and Embodiment 6, a self-lubricating bearing or a needle bearing and the like can be arranged between the support sleeve 42 and the connecting sleeve 44 to reduce friction.

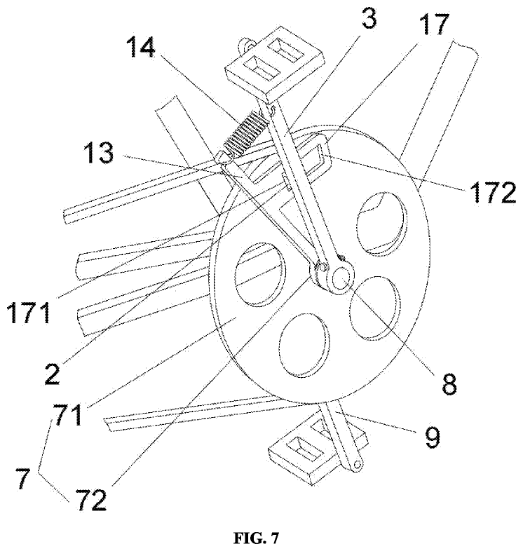

Referring to FIG. 7, an Embodiment 7 of the present disclosure includes: a tension rod 13, a tension spring 14, a right crank 3, a chainring 7 and a bottom bracket 8. A left crank 9 and the right crank 3 are fixedly connected to left and right ends of the bottom bracket 8. The chainring 7 is sleeved on the bottom bracket 8 or sleeved on the cylindrical portion of the right crank 3, and is configured to be rotatable on the bottom bracket 8 or rotatable on the cylindrical portion of the right crank 3. That is, the chainring 7 is rotatably connected to the bottom bracket 8 or rotatably connected to the cylindrical portion of the right crank 3. A lower end of the tension rod 13 is fixed on the chainring 7. The connecting block 17 is fixed on a front side of the tension rod 13 and the connecting block 17 is formed with a slot. The stop block 2 fixed on the right crank 3 is inserted into the slot of the connecting block 17, and two ends of the tension spring 14 are connected to upper portions of the right crank 3 and the tension rod 13. A first inner wall surface 171 of the slot of the connecting block 17 is configured to block the stop block 2 to preload the tension spring 14. When depressing the pedal increases the tension in the tension spring 14 and extends it to a certain extent, the stop block 2 comes into contact with a second inner wall surface 172 of the slot of the connecting block 17, after which any further increase in the driving force is directly transmitted to the chainring 7 via the tension rod 13, thereby preventing the tension spring 14 being damaged due to excessive force. In the present embodiment, the principle and process to enable the pedal to easily pass the top dead center are substantially the same as those in Embodiment 1 and Embodiment 2.

It is to be noted that in Embodiment 7, the chainring 7 is composed of a sprocket 71 and a bushing 72 fixed together, which is the same as in Embodiments 1 and 2. The tension rod 13 is fixed on the bushing 72.

The flexible transmission structures in the above embodiments can also be applied to pedal-driven vehicles such as tricycles.

What is claimed is:

1. A flexible transmission structure of a bicycle, comprising a spring, a connection auxiliary component and transmission components, wherein the spring and the connection auxiliary component are arranged between the transmission components of the bicycle, allowing an elastic connection between the transmission components and enabling a flexible transmission system for the bicycle.

2. The flexible transmission structure of the bicycle according to claim 1, wherein the transmission component comprises a right crank and a chainring, a left crank and the right crank being fixedly connected to left and right ends of a bottom bracket; and wherein the chainring is sleeved on the bottom bracket or sleeved on the cylindrical portion of the right crank and is configured to be rotatable on the bottom bracket or rotatable on the cylindrical portion of the right crank.

3. The flexible transmission structure of the bicycle according to claim 1, wherein the transmission component comprises: a sprocket, a frame, a freewheel and a chain; wherein the length of the chain is configured to be increased to allow slack in its free state; and wherein the spring and the connection auxiliary component are arranged between the frame and an upper section of the chain configured to transmit power, thereby applying a vertical elastic force to the upper section of the chain, forming the upper section into a curve to increase its length, and enabling an elastic or flexible connection in the upper section configured to transmit power between the sprocket and the freewheel.

4. The flexible transmission structure of the bicycle according to claim 1, wherein the connection auxiliary component comprises a support sleeve, a retaining ring and a connecting sleeve; wherein the transmission component comprises a freewheel and a rear wheel or a rear wheel hub, the support sleeve being fixed to a right side of the rear wheel hub of the bicycle, the connecting sleeve being sleeved on the support sleeve and being configured to be rotatable on the support sleeve, the retaining ring being configured to prevent the connecting sleeve from disengaging from the support sleeve, and the freewheel being fixedly connected to the connecting sleeve.

5. The flexible transmission structure of the bicycle according to claim 2, wherein the spring is a compression spring; wherein the connection auxiliary component comprises a load-bearing rod and a stop block, the load-bearing rod and the stop block being fixed on the chainring, and the load-bearing rod being arranged on a front side of the right crank; wherein when the right crank is driven to rotate on the bicycle, one side in front of the right crank is referred to as the front side and one side behind it as a rear side, the stop block being arranged on the rear side of the right crank; wherein a load block is fixed on the load-bearing rod, spring seats being fixed on upper portions of the load-bearing rod and the right crank respectively, two ends of the compression spring being sleeved on the two spring seats, and the stop block being configured to abut against the right crank to preload the spring.

6. The flexible transmission structure of the bicycle according to claim 2, wherein the spring is a tension spring; and wherein the connection auxiliary component comprises: a tension rod, a load block and a stop block, the tension rod and the load block being fixed on the chainring, the tension rod being arranged on a rear side of the right crank, the load block being arranged on a front side of the right crank, two ends of the tension spring being connected to upper portions of the right crank and the tension rod, and the stop block fixed on the right crank being configured to abut against the tension rod to preload the tension spring.

7. The flexible transmission structure of the bicycle according to claim 3, wherein the spring is a tension spring; wherein the connection auxiliary component comprises: an upper swing rod, a tension pulley, a limit rod, a tension wheel, a lower swing rod and a torsion spring;
wherein one end of the upper swing rod is hinged to the frame while the other end thereof is connected to the tension pulley; wherein one end of the lower swing rod is hinged to the frame while the other end thereof is connected to the tension wheel; wherein the tension spring is arranged below the upper swing rod, one end of the tension spring being connected to the upper swing rod while the other end thereof connected to the frame; wherein the tension pulley is configured to press downward against the upper section of the chain configured to transmit power between the sprocket and the freewheel; wherein a lower end of the limit rod is fixed on the frame while an upper end thereof abuts against a lower side of the upper swing rod; wherein two arms of the torsion spring are configured to abut against the frame and the lower swing rod respectively; and wherein the tension wheel is configured to press downward against a lower section of the chain, thereby maintaining the lower section of the chain under tension to prevent chain slack or derailment.

8. The flexible transmission structure of the bicycle according to claim 3, wherein the spring is a tension spring; wherein the connection auxiliary component comprises: an upper swing rod, a tension pulley, a limit rod, a tension wheel, a lower swing rod and a torsion spring; wherein one end of the upper swing rod is hinged to the frame while the other end thereof is connected to the tension pulley; wherein one end of the lower swing rod is hinged to the frame while the other end thereof is connected to the tension wheel; wherein the tension spring is arranged above the upper swing rod, one end of the tension spring being connected to the upper swing rod while the other end thereof connected to the frame; wherein the tension pulley is configured to push upward against the upper section of the chain configured to transmit power between the sprocket and the freewheel; wherein a lower end of the limit rod is fixed on the frame while an upper end thereof hooks onto the upper swing rod; wherein two arms of the torsion spring are configured to abut against the frame and the lower swing rod respectively; and wherein the torsion spring is configured to enable the tension wheel to push upward against a lower section of the chain, thereby maintaining the lower section of the chain under tension.

9. The flexible transmission structure of the bicycle according to claim 4, wherein the spring is a tension spring; wherein the connection auxiliary component further comprises: a load block, a driven rod and a tension rod, the load block and the tension rod being fixed on the connecting sleeve, the driven rod being fixed on the support sleeve, and the driven rod being arranged on a rear side of the tension rod; and wherein when the freewheel and the tension rod are driven to rotate on the bicycle, one side in front of the tension rod is referred to as a front side and one side behind it as the rear side, the load block being arranged on the rear side of the driven rod, two ends of the tension spring being connected to respective upper portions of the tension rod and the driven rod, and a stop block fixed on the tension rod being configured to abut against the driven rod to preload the tension spring.

10. The flexible transmission structure of the bicycle according to claim 4, wherein the spring is a compression spring; and wherein the connection auxiliary component further comprises: a driving rod, a driven rod and a stop block, the driving rod being fixed on the connecting sleeve, the driven rod and the stop block being fixed on the support sleeve, the driven rod being arranged on a front side of the driving rod, two ends of the compression spring being sleeved on spring seats on respective upper portions of the driving rod and the driven rod, the stop block being arranged on a rear side of the driving rod and being configured to abut against the driving rod to preload the compression spring, and a load block being fixed on the driven rod.

11. The flexible transmission structure of the bicycle according to claim 2, wherein the spring is a tension spring; and wherein the connection auxiliary component comprises: a tension rod, a connecting block and a stop block, a lower end of the tension rod being fixed on the chainring, the connecting block being fixed on a front side of the tension rod and the connecting block being formed with a slot, the stop block fixed on the right crank being inserted into the slot of the connecting block, and two ends of the tension spring being connected to upper portions of the right crank and the tension rod.
